(19) United States
(12) Patent Application Publication
(10) Pub. No.: US 2022/0267188 A1
(43) Pub. Date: Aug. 25, 2022

(54) METHOD FOR PRODUCING A THREE-DIMENSIONAL GLASS OBJECT AND GLASS FIBRES SUITABLE FOR THEREFOR

(71) Applicant: Heraeus Quarzglas GmbH & Co. KG, Hanau (DE)

(72) Inventors: Miriam Sonja HÖNER, Hanau (DE); Achim HOFMANN, Hanau (DE)

(73) Assignee: Heraeus Quarzglas GmbH & Co. KG, Hanau (DE)

(21) Appl. No.: 17/623,062

(22) PCT Filed: Apr. 30, 2020
(86) PCT No.: PCT/EP2020/062022

§ 371 Date: Dec. 27, 2021

(30) Foreign Application Priority Data
Jun. 27, 2019 (EP) 19182983.7

(51) Int. Cl. C03B 29/04; C03B 37/15; C03C 25/24; B32B 17/02

(52) U.S. Cl. CPC C03B 29/04; C03B 37/15; C03C 25/24; B32B 17/02; C03B 2201/02

(57) ABSTRACT

Known methods of producing a three-dimensional glass object comprise the step of shaping of a glass fiber, wherein the glass fiber provided with a protective sheath is fed continuously to a heating source, the protective sheath is removed under the influence of heat, and the glass fiber is softened. In order to facilitate the production of filigree or optically distortion-free and transparent glass objects as much as possible, and also enable the adjustment of optical and mechanical properties with high spatial resolution, in one aspect the glass fiber has a protective sheath with a layer thickness in the range of 10 nm to 10 μm.

### TECHNICAL FIELD

The present invention relates to a method of producing a three-dimensional glass object, in particular from quartz glass, comprising the step of shaping of a glass fiber, wherein the glass fiber provided with a protective sheath is continuously fed to a heating source, the protective sheath is removed under the influence of heat, and the glass fiber is softened.

The invention also relates to a glass fiber for the manufacture of a three-dimensional glass object, wherein the glass fiber is provided with a protective sheath.

Complex glass components are produced industrially by a glass pressing technique or melt forming method. These processes are laborious and require high processing temperatures as well as special tools and molds, which can lead to defects and faults within the glass structure and on the surface.

Additive manufacturing techniques are becoming increasingly important, particularly for producing models and prototypes or for small objects and numbers of units, allowing rapid manufacture of complex geometries without elaborate tools. Examples of additive manufacturing techniques are stereolithography, selective laser melting or sintering, and three-dimensional printing. Here, solid, liquid or powdered starting substances are dispensed on to a base (substrate, platform) in a spatially and temporally controlled manner, and joined together in layers to form real three-dimensional objects on the basis of calculated models.

### Background Art

First additive manufacturing techniques for producing glass employed shapeless starting substances, such as for example glass powder or glass melt. In contrast, Junjie Luo; Luke J. Gilbert; Douglas A. Bristow; Robert G. Landers; Jonathan T. Goldstein; Augustine M. Urbas; Edward C. Kinzel, in “Additive manufacturing of glass for optical applications” (Laser 3D Manufacturing III, Proc. of SPIE, Vol. 9738, 2016), propose the production of objects from quartz glass by successive welding of quartz glass filaments. The filaments, which consist of uncoated quartz glass fibers with a nominal outer diameter of 0.5 mm, are fed in a straight line to a beam of a CO₂ laser, melted there and welded on a substrate in layers to form a glass object.

Uncoated quartz glass fibers are fragile, however, and must not be bent during their handling and processing; this prevents the glass filaments from being stored on and unwound from a winding reel, for example.

This disadvantage is avoided by a technique of the type mentioned above, in which glass filaments are employed which are surrounded by a plastic protective sheath. A method of this type is described by P. von Witzendorff; L. Pohl; O. Suttmann; P. Heinrich; A. Heinrich; J. Zander; H. Bragard and S. Kaierle in “Additive manufacturing of glass: CO₂-Laser glass deposition printing”; Procedia CIRP 74 (2018), S. 272-275. DOI: https://doi.org/10.1016/j.procir.2018.08.109.

Here, a 0.4 mm thick glass fiber with a fiber core composed of quartz glass and a 50 μm thick plastic protective sheath is fed virtually endlessly from a winding reel to a defocused beam of a CO₂ laser. The protective sheath is burnt off by the laser beam here before the quartz glass of the fiber core melts.

EP 3 034 480 A1 concerns the production of bioactive tissues and fabrics from glass fibers for use in the medical and dental sector. The bioactive glass fiber can additionally be coated with an at least 250 nm thick bioactive substance, such as collagen I which is readily absorbable in the body.

From JP H05294676 A, a glass fiber with a layer composed of a saturated higher fatty acid and/or an alkyl polysiloxane is known. The layer thickness is approximately 0.1 μm.

Leonhard Pohl, Philipp von Witzendorff, Elisavet Chatzizyrli, Oliver Suttmann, Ludger Overmeyer, in “CO₂ laser welding of glass: numerical simulation and experimental study”; The International Journal of Advanced Manufacturing Technology; Vol. 90, (2017); 397-403, describe the production of three-dimensional objects from glass using a glass fiber with a diameter of 0.4 mm and a 50 μm thick plastics layer. The glass fiber is fed in a straight line to a beam of a CO₂ laser and melted there. The feed rate is 300 mm/min.

### Technical Problem

The thickness of approx. 60 μm for the protective sheath is a standard thickness for optical glass fibers, applied for example as a UV-curable coating during the fiber drawing process. This thickness is necessary to provide the fiber with long-term mechanical and optical protection from degradation.

However, plastics residues from the protective sheath are not acceptable in the 3D object and must be removed completely. When the plastic protective sheath is burnt off, large quantities of gases and impurities are formed, which precipitate on the surrounding surfaces and prevent or impede a bubble-free and inclusion-free fusion of the quartz glass fiber.

It is reported that, with the same laser power, the viscosity of the glass and the melting behavior of the glass fiber on the base depend on the heating period in the laser beam and thus on the fiber feed rate. As the rate increases, the application of the glass material varies between vaporizing of the glass material (temperature too high), discontinuous, dropwise melting, continuous melting, and lack of a fused joint (temperature too low).

The need to burn off the plastic protective sheath completely before the glass fiber melts sets an upper limit to the scope for the fiber feed rate and thus slows down the mass deposition rate (in g/min). This becomes noticeable particularly when a 3D object with high spatial resolution is desired, which requires the use of small fiber diameters of e.g. less than 100 μm and which can limit the mass deposition rate to low values that are no longer economically viable.

It has also been shown that the glass fiber provided with a standard plastic protective sheath displays a marked tendency to deform when heated. In particular, twists of the glass fiber around the fiber's longitudinal axis make it difficult to maintain the desired contour of the glass object as predefined by a model and also, for example, even make the linear welding on the substrate more difficult.

The invention is therefore based on the object of providing a manufacturing process using glass filaments, in particular quartz glass fibers, which is economical and facilitates the production of filigree glass objects or glass objects that are optically as distortion-free and transparent as possible, and which also in particular allows optical and mechanical properties to be adjusted with high spatial resolution.

The invention is also based on the object of providing a glass fiber, in particular a glass fiber composed of quartz glass, which is particularly adapted and suitable for use in the manufacturing method according to the invention.

### SUMMARY OF THE INVENTION

With respect to the method, this object is achieved according to the invention, starting from a method of the type mentioned above, by the fact that the glass fiber has a protective sheath with a layer thickness in the range of 10 nm to 10 μm.

The glass fiber can be used to produce a three-dimensional glass object, in particular from quartz glass. The manufacturing method using glass filaments will also be referred to below as the “build-up welding method”. The use of a glass fiber provided with a protective sheath according to the invention has a number of advantages:
(1) The thickness of the protective sheath of at least 10 nm, preferably at least 50 nm, is sufficient to protect the glass fiber from mechanical damage when used as an intermediate product, as here. As a result, according to a preferred method variant the glass fiber can, for example, be stored on a winding reel with a winding diameter of less than 30 cm, and continuously unwound therefrom and fed to the heating source during the build-up welding process.
   The glass fiber has for example a diameter in the range of 20 μm to 1000 μm, preferably a diameter in the range of 50 μm to 300 μm. The data relating to the diameter of the glass fiber refer here and below to the diameter without the protective sheath. In the case of glass fibers with a non-circular—for example an oval or polygonal—cross-sectional contour, the data relating to the diameter of the glass fiber refer to the diameter of the circumscribed circle surrounding the contour.
(2) The protective sheath is removed from the glass fiber immediately before the glass fiber is melted under the influence of the heat of the heating source and without mechanical contact with a tool. The removal takes place for example by vaporizing, optionally assisted by combustion (pyrolysis) of components of the protective sheath. In the simplest case, the removal of the protective sheath takes place solely under the influence of the heating source that is also employed for softening the glass fiber. However, additional heating sources or other auxiliary means that are, for example, specially adapted for the oxidative combustion of the protective sheath can also be employed.
   In this case, the low thickness of less than 10 μm, preferably less than 5 μm, particularly preferably less than 1 μm, contributes to the fact that the protective sheath can be vaporized and/or pyrolyzed within a short time with, as far as possible, no residues. This allows a high feed rate of the glass fiber accompanied by a sufficiently high mass deposition rate even with a small diameter of the glass fiber.
(3) The low thickness of the protective sheath also allows the longitudinal portion in which the protective sheath is removed as a result of the action of the heating source to be kept short. The glass fiber may no longer be bent and may no longer be touched in this longitudinal portion, so that it cannot sustain any damage and cannot break. This longitudinal portion is therefore as short as possible and preferably has a length in the range of 0.5 to 2 cm.
(4) It has been shown that the glass fiber that has been freed from the low-thickness protective sheath displays no significant tendency to deform, which facilitates fiber guidance and allows higher positioning accuracy and a precisely contoured shaping or welding of the fiber layer, and in particular also a linear welding on a base. This facilitates the production of glass objects that are optically as distortion-free as possible, as well as adherence to optical and mechanical properties defined by a model.

The method according to the invention using a glass fiber with a low-thickness protective sheath permits a relatively high feed rate of the glass fiber to the heating source, which is preferably at least 300 mm/min, preferably at least 450 mm/min.

The high feed rate that is made possible by the thin protective sheath ensures that the build-up welding method can be carried out economically at a high mass deposition rate.

The protective sheath preferably contains only the components carbon, silicon, hydrogen, nitrogen, and oxygen.

These components can be removed without residues via the gaseous phase. The formation of toxic substances or undesirable carbon black particles and solids that lead to contamination of the glass object is avoided.

It has proved expedient if the protective sheath contains an organic material with a decomposition temperature of less than 400° C.

The removal of the protective sheath takes place completely or at least partially by thermal decomposition of the protective sheath material, for example, generally in combination with an oxidation reaction. The lower the decomposition temperature, the more rapidly the protective sheath material is removed.

Suitable organic materials that are distinguished by a low decomposition temperature are polysaccharides or surfactants, in particular cationic surfactants, or polyether polymers, such as for example polyethylene glycol, polyalkylene glycol, polyethylene oxide, and/or polyalkylene oxide.

Alternatively, the protective sheath is produced from one or more fluorine-free silanes and/or from fluorine-free surfactants, in particular cationic fluorine-free surfactants.

Because the starting substances are free from fluorine, the release of fluorine during removal of the protective sheath, and the reaction to form hydrofluoric acid, accompanied by a corrosive attack on the glass of the glass fiber or of the three-dimensional glass object, are avoided.

In commercial optical fibers for telecommunications, the protective sheath is conventionally applied directly to the freshly drawn glass fiber during the fiber drawing process by passing said glass fiber through a coating cup, in which the protective sheath material is contained in monomeric, liquid form. The glass fiber that has been wetted with the monomer leaves the coating cup via a die, which determines the thickness of the adhering monomer layer and strips off the excess monomer material. To avoid damaging the glass fiber surface, a minimum distance between the die wall and the glass fiber should be observed, which determines the minimum thickness of the protective sheath after the monomer layer has cured.

In the method according to the invention, a protective sheath with a low thickness is produced on the glass fiber, which thickness can be adjusted only with difficulty by way of a die owing to the requirement for said minimum distance. The protective sheath is therefore produced on the glass fiber preferably by dipping or roller coating.

The protective sheath in this case is applied to the glass fiber not by a die, but for example by dipping the glass fiber into a bath containing a coating solution from which the protective sheath is produced, or by passing the glass fiber over a roller surface on which a film of the coating solution is located. Since the protective sheath only has to provide a temporary mechanical protection, it can even be produced with thin, for example even aqueous, coating solutions.

The heating source serves to melt the glass fiber, assisting or causing the removal of the protective sheath and softening the surface of the base that may be present during build-up welding, thus promoting adhesion between the molten glass of the glass fiber and the base. When a laser beam is employed as the heating source, it has proved expedient if the glass fiber's longitudinal axis forms an angle in the range of between 30 and 100 degrees with the main extension direction of the laser beam. This angle influences the beginning of the region of action of the laser beam on the protective sheath. The more acute the angle, the earlier the laser beam heats the protective sheath.

With regard to the glass fiber for the manufacture of a three-dimensional glass object, the aforementioned technical problem is solved according to the invention, starting from a glass fiber of the type mentioned above, by the fact that the glass fiber has a protective sheath with a layer thickness in the range of 10 nm to 10 μm.

The glass fiber that has been provided with a protective sheath according to the invention is particularly suitable as an intermediate product for use in an additive manufacturing method, such as for example in a build-up welding process, and in particular in a method according to the present invention as described in more detail above:
(1) The thickness of the protective sheath of at least 10 nm, preferably at least 50 nm, is sufficient to protect the glass fiber from mechanical damage as an intermediate product. As a result, for example, according to a preferred embodiment, for a diameter in the range of 20 μm to 1000 μm, preferably with a diameter in the range of 50 to 300 μm, it can be stored on a winding reel with a winding diameter of less than 30 cm, and continuously unwound therefrom during the build-up welding process.
(2) The protective sheath has a thickness of less than 10 μm, preferably less than 5 μm, particularly preferably less than 1 μm. It is relatively thin and can be vaporized and/or pyrolyzed within a short time with, as far as possible, no residues.
(3) The glass fiber that has been freed from the low-thickness protective sheath displays no significant tendency to deform, which facilitates fiber guidance during the build-up welding method and allows higher positioning accuracy and a precisely contoured shaping or welding of the fiber layer, and in particular also a linear welding on a base or precise hardening in air.

The use of the glass fiber according to the invention in a build-up welding method facilitates the production of glass objects that are optically as distortion-free as possible, as well as adherence to optical and mechanical properties defined by a model; also a relatively high feed rate of the glass fiber to the heating source, and therefore the build-up welding method can be carried out economically at a high mass deposition rate.

Advantageous embodiments of the glass fiber according to the invention can be taken from the subclaims. To the extent that embodiments of the glass fiber specified in the subclaims are based on the procedures mentioned in subclaims relating to the method according to the invention, reference should be made to the above statements relating to the corresponding method claims for supplementary explanation.

### Definitions

### Glass Fiber

The glass fiber (synonymous with “glass filament”) consists of glass. The glass is for example a one-component glass such as quartz glass, or it is a multi-component glass such as borosilicate glass. The one-component glass can contain additional dopants. Quartz glass is understood here to be a glass that has an SiO₂ content of at least 90 wt. %.

The glass fiber is solid or contains one or more hollow channels (also referred to below as “capillaries”) or a doped core. In a glass fiber with a hollow channel, the central axis of the hollow channel preferably extends in the fiber's longitudinal axis.

The glass fiber (or capillary) has a cross-section (viewed along the fiber's longitudinal axis) which is circular or non-circular. The non-circular cross-section is for example oval, polygonal, in particular square, rectangular, hexagonal, octagonal, or it is trapezoidal, ribbed, star-shaped or has flat areas or inwardly (concave) or outwardly (convex) curved areas on one or more sides.

### EXEMPLARY EMBODIMENTS

The invention will be explained in more detail below with the aid of an exemplary embodiment and a drawing. In detail, the figures show schematic diagrams of the following.

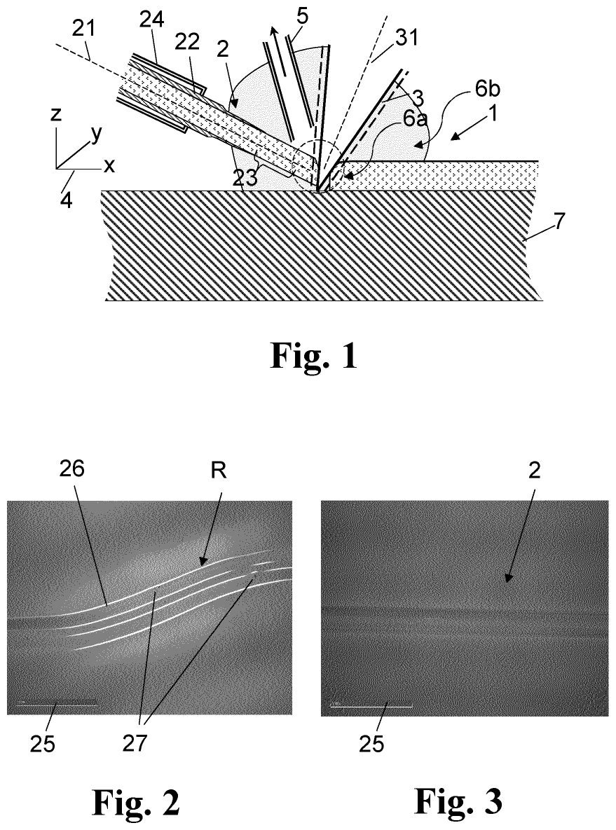

FIG. 1: a first embodiment of the experimental set-up for carrying out tests on build-up welding using glass filaments according to the invention,

FIG. 2: a microscope image of a preliminary build-up welding test using a reference glass fiber,

FIG. 3: a microscope image of a preliminary build-up welding test using a glass fiber according to the invention, and

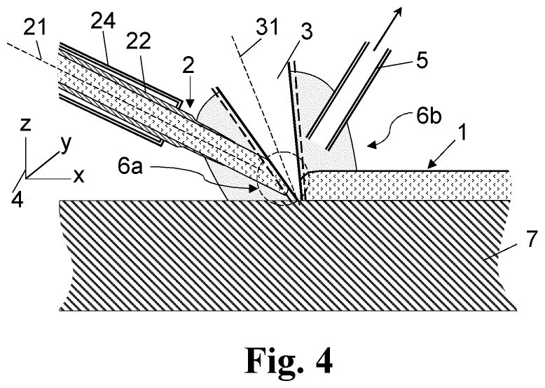

FIG. 4: a further embodiment of the experimental set-up for carrying out tests on build-up welding using glass filaments according to the invention.

### PRELIMINARY TESTS

To examine the handling characteristics, weldability and general behavior, preliminary build-up welding tests were performed on quartz glass fibers with different protective sheaths. Results are shown in the microscope images of FIGS. 2 and 3. The scale bars 25 each denote a length of 1 mm.

In these tests, quartz glass fibers with a diameter of 220 μm and with a standard plastics sheath with a thickness of approx. 62.5 μm were employed as reference fibers “R”, and they were performed with quartz glass fibers with the same diameter but with a thin sheath according to the invention (glass fibers 2). The sheath has a thickness of less than 50 nm. Its composition and production will be explained in more detail below.

The quartz glass fibers (R; 2) were each placed directly on a quartz glass sheet and affixed with adhesive tape. An oxyhydrogen heating torch was used in each case as the heating source for softening the quartz glass fibers and burning off the coatings. The oxyhydrogen torch provided the heat needed to melt the quartz glass fibers and at the same time oxygen for the pyrolysis of the protective sheath because of hyperstoichiometric oxygen in the oxyhydrogen flame.

### Observations and Results:

It was shown that the reference glass fiber “R” always moved and twisted under the influence of the heating torch. This can be explained by the gases arising, as well as non-axial stresses caused by the non-uniform burning off of the coating. For this reason, the ends of the fiber were fastened to the quartz glass sheet with adhesive tape before welding, in order to at least limit this movement.

This behavior was not displayed by the glass fibers 2 with the thin coating. This glass fiber 2 was significantly easier to handle during welding and also did not have to be secured.

Both types of fiber were able to be welded on to the substrate 7. Despite being secured, however, the reference glass fibers R could not be welded on to the substrate 7 in a straight line. The waviness of the welded fibers was 5 mm per 120 mm welded length for the reference glass fiber, and in the case of the glass fiber 2 according to the invention a highly rectilinear weld was obtained without significant waviness.

The bright reflections 26 on the image of FIG. 2 make the twisting of the reference glass fiber on the base clear. The black dots 27 additionally show that more bubbles formed along the welded length in the reference glass fiber R than in the glass fiber 2 according to the invention. For every 5 cm length, twenty-one bubbles were counted in the reference glass fiber R.

FIG. 3 shows the result of the welding test using the glass fiber 2 according to the invention. This shows a rectilinear course along the welded length and, in addition, a low number of only six bubbles for a 5 cm length.

FIG. 1 is a diagram of the experimental set-up for carrying out the additive manufacture of a glass object 1 by build-up welding using a glass fiber 2 that has been determined to be suitable with the aid of the preliminary tests.

Here, the glass fiber 2 wound on a winding reel with a minimum diameter of 30 cm is unwound from the winding reel continuously by means of a fiber-guiding system (not shown in the figure) and fed through a guide sleeve 24 to a melting zone 6a, in which a defocused laser beam 3 acts as a heating source. Peaks in heat distribution are compensated by the defocusing, which is indicated in the figure as a broken line around the laser beam 3. Ideally, the laser beam 3 is approximately twice as wide at the point of impingement as the diameter of the glass fiber 3 to be melted, so that both the glass fiber 3 and the surrounding region, and in particular the substrate 7, are heated.

The glass fiber's longitudinal axis 21 here forms an angle of approx. 90 degrees with the main extension direction 31 of the laser beam 3. A CO₂ laser with a maximum output power of 120 W is used as the laser. The laser beam 3 melts the end of the glass fiber 2 continuously, and it heats the protective sheath 22 of the glass fiber so that this is thermally decomposed. In addition, it softens the surface of the substrate 7, thus promoting adhesion between molten glass of the glass fiber 2 and the glass substrate 7. The heating zone produced by the laser beam 3 is indicated schematically in FIG. 1 by the region 6b shaded in grey.

A suction tube 5 projects as close as possible to the melting zone 6a. The platform consisting of a glass substrate 7 lies on a digitally controlled translation stage (indicated by the x-y-z system of coordinates 4) and is displaceable in all spatial directions.

The glass fiber 2 has a circular cross-section and a diameter of 220 μm. It is provided with a very thin sheath 22 having a thickness of less than 100 nm.

The (thin) layer 22 is produced by drawing the glass fiber 2 through a 10% aqueous solution of cetyltrimethylammonium chloride.

The layer 22 has a decomposition temperature of less than 400° C. It is so thin that it can be completely burnt off rapidly and efficiently online, immediately upstream of the melting zone 6a, while the glass fiber 2 is continuously fed further to the melting zone 6a.

This allows a high processing speed. The glass fiber feed rate to the melting zone 6a is adjusted to a value in the range of 300 to 600 mm/min such that the 22 is always completely removed before the glass fiber 2 reaches the melting zone 6a, and in addition such that the longitudinal portion 23 in which the sheath 22 has already been completely removed has a length of less than 2 cm. As a result, mechanical damage to the uncoated glass fiber 2 is prevented.

In addition, owing to the low layer thickness of the sheath 22, only a few combustion products are obtained, which can be readily removed by means of the suction 5. This allows bubble-free fusion of the glass fiber 2 with the substrate 7.

The result of the welding of glass fiber 2 and substrate 7 is a three-dimensional glass object 1 without defects and bubbles.

FIG. 4 is a diagram of a variation of the experimental set-up for carrying out the additive manufacturing of a glass object. The same reference numerals as in FIG. 1 are used here to denote identical or equivalent components of the set-up.

In contrast to the set-up of FIG. 1, the glass fiber's longitudinal axis 21 here forms a somewhat more acute angle of 45 degrees with the main extension direction 31 of the laser beam 3. As a result of the different orientation of the laser beam 3 compared to FIG. 1, the heating region 6b also displays a different extension and a different focus. It covers a larger region of the glass fiber 2 and thus brings about a more effective heating of glass fiber 2 and protective sheath 22 at the same temperature.

In this case too, the suction tube 5 is brought as close as possible to the melting zone 6a.

1-16. (canceled)

17. A method of producing a three-dimensional object from quartz glass, comprising:
shaping a glass fiber;
wherein the glass fiber is provided with a protective sheath and is continuously fed to a heating source;
wherein the protective sheath is removed under the influence of the heating source, and the glass fiber is softened; and
wherein the protective sheath of the glass fiber has a layer thickness in the range of 10 nm to 10 μm.

18. The method according to claim 17, wherein the protective sheath of the glass fiber has a layer thickness of less than 1 μm.

19. The method according to claim 17, wherein the glass fiber is fed to the heating source at a feed rate of at least 450 mm/min.

20. The method according to claim 17, wherein the glass fiber has a diameter in the range of 50 μm to 300, and is wound on a take-up reel and is fed to the heating source by unwinding from the take-up reel.

21. The method according to claim 17, wherein a longitudinal section of the glass fiber, in which the protective sheath has been removed, has a length in the range of 0.5 to 2 cm.

22. The method according to claim 17, wherein the protective sheath consists only of the components carbon, silicon, hydrogen, nitrogen, and oxygen.

23. The method according to claim 17, wherein the protective sheath has a decomposition temperature of less than 400° C.

24. The method according to claim 17, wherein the protective sheath consists of an organic material, of polysaccharides or surfactants, of cationic surfactants, or of a polyether polymer, polyethylene glycol, polyalkylene glycol, polyethylene oxide or polyalkylene oxide.

25. The method according to claim 17, characterized in that the protective sheath is produced from one or more fluorine-free silanes or from fluorine-free surfactants, or cationic fluorine-free surfactants.

26. The method according to claim 17, wherein the protective sheath is produced on the glass fiber by dipping or roller coating.

27. A glass fiber for the manufacture of a three-dimensional object from glass, wherein the glass fiber is provided with a protective sheath having a layer thickness in the range of 10 nm to 10 μm.

28. The glass fiber according to claim 27, wherein the protective sheath has a layer thickness in the range of of less than 1 μm.

29. The glass fiber according to claim 27, wherein the glass fiber has a diameter in the range of 50 μm to 300 μm.

30. The glass fiber according to claim 27, wherein the glass fiber is wound on a take-up reel with a minimum winding diameter of less than 30 cm.

31. The glass fiber according to claim 27, wherein the protective sheath contains an organic material with a decomposition temperature of less than 400° C.

32. The glass fiber according to claim 27, wherein the protective sheath consists of an organic material, of polysaccharides or of surfactants, of cationic surfactants, or of a polyether polymer, polyethylene glycol, polyalkylene glycol, polyethylene oxide or polyalkylene oxide.
